(19) United States
(12) Patent Application Publication
(10) Pub. No.: US 2010/0071529 A1
(43) Pub. Date: Mar. 25, 2010

(54) MUSICAL STRING

(75) Inventor: PETER INFELD, Wien (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: Thomastik-Infeld Gesellschaft m.b.H., Wien (AT)

(21) Appl. No.: 12/171,628

(22) Filed: Jul. 11, 2008

(51) Int. Cl. G10D 3/10

(52) U.S. Cl. 84/297 S

(57) ABSTRACT

For achieving a high tuning stability and sound rich in timbre it is provided in a musical string (1), especially for plucked and/or stringed instruments, with the musical string (1) having at least one core (2) and with the musical string (1) having at least one sheathing (3) which is arranged about the first core (2), that the core (2) comprises a predeterminable plurality of metal wires (4) which are stranded together with each other.

The invention relates to a musical string according to the preamble of claim 1.

Known musical strings with a core made of natural gut or silk have a number of disadvantages such as low tuning stability and large differences between the actually similar products due to the high form tolerances which are unavoidable in natural products. Such musical strings further show a number of acoustic problems. The sound producible with such musical strings meets requirements of current concert operations only within limits.

It is therefore the object of the invention to provide a musical string of the kind mentioned above with which the mentioned disadvantages can be avoided and which especially offers high tuning stability and has a sound rich in timbre.

This is achieved in accordance with the invention by the features of claim 1.

A musical string can accordingly be formed which has a very natural and warm sound. Moreover, such a musical string has a high tuning stability and it is not necessary to re-tune the instrument as frequently as conventional musical strings. Musical strings in accordance with the invention also respond less strongly than known musical strings to a change of location and changes in weather. As a result of a core made of a rope, such a musical string has a low bending stiffness, thus allowing the generation and formation of a large number of upper harmonics. Musical strings in accordance with the invention therefore have a sound rich in timbre.

The sub-claims, which like claim 1 simultaneously form a part of the description, relate to further advantageous embodiments of the invention.

The invention is now explained in closer detail by reference to the enclosed drawings which merely show preferred embodiments in an exemplary manner, wherein:

FIG. 1 shows a first preferred embodiment of a musical string in accordance with the invention in a sectional view;

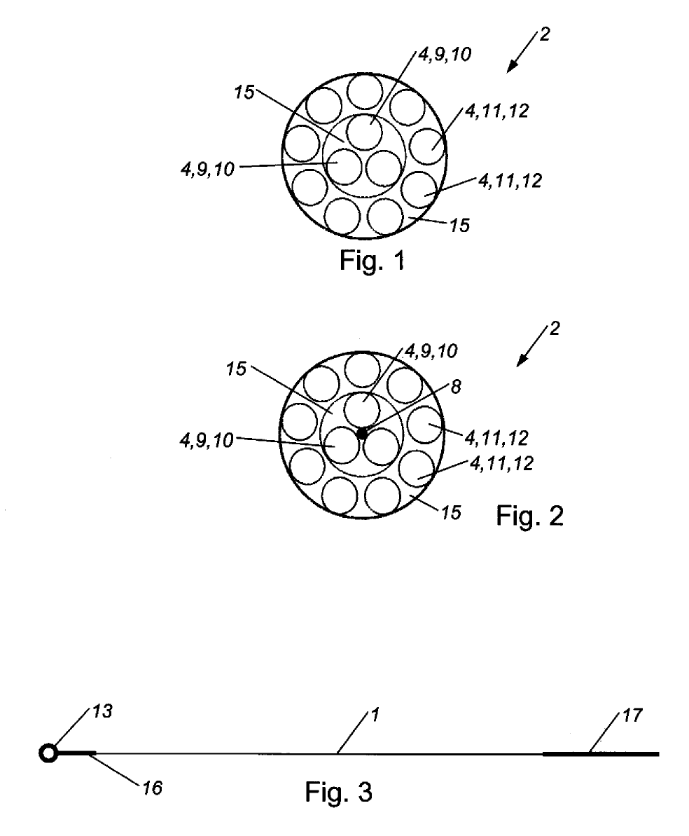

FIG. 2 shows a musical string in accordance with the invention in a sectional view;

FIG. 3 shows a musical string in a complete view;

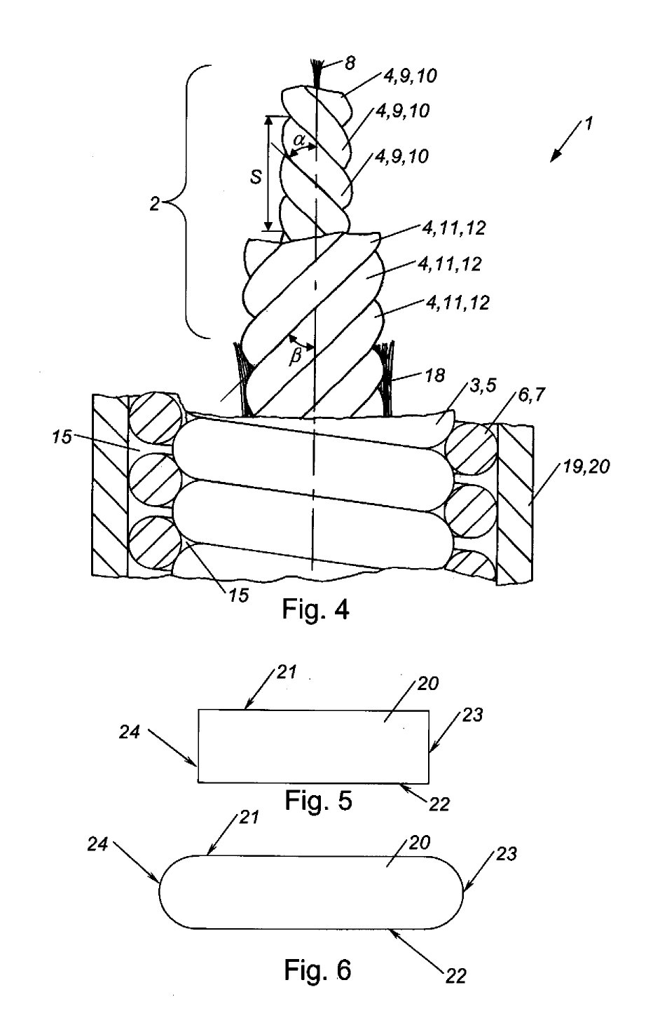

FIG. 4 shows a preferred embodiment of a musical string in accordance with the invention in a partly sectional view;

FIG. 5 shows a first preferred embodiment of a strip in a cross section;

FIG. 6 shows a second preferred embodiment of a strip in a cross section;

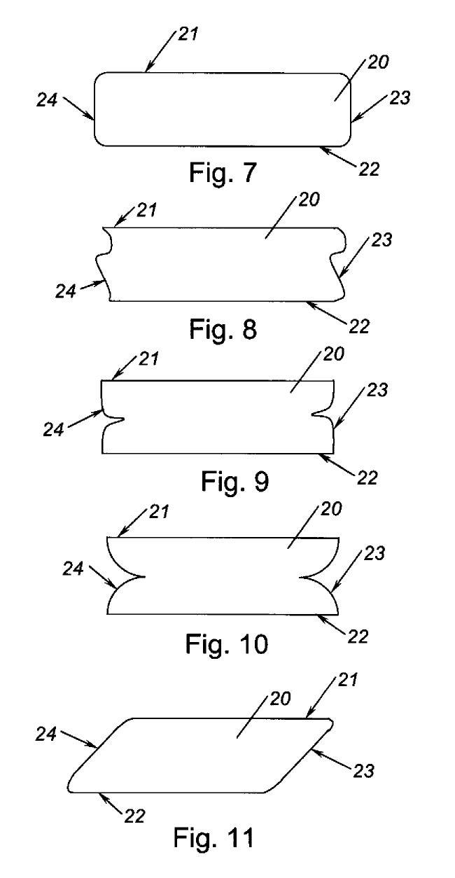

FIG. 7 shows a third preferred embodiment of a strip in a cross section;

FIG. 8 shows a fourth preferred embodiment of a strip in a cross section;

FIG. 9 shows a fifth preferred embodiment of a strip in a cross section;

FIG. 10 shows a sixth preferred embodiment of a strip in a cross section;

FIG. 11 shows a seventh preferred embodiment of a strip in a cross section;

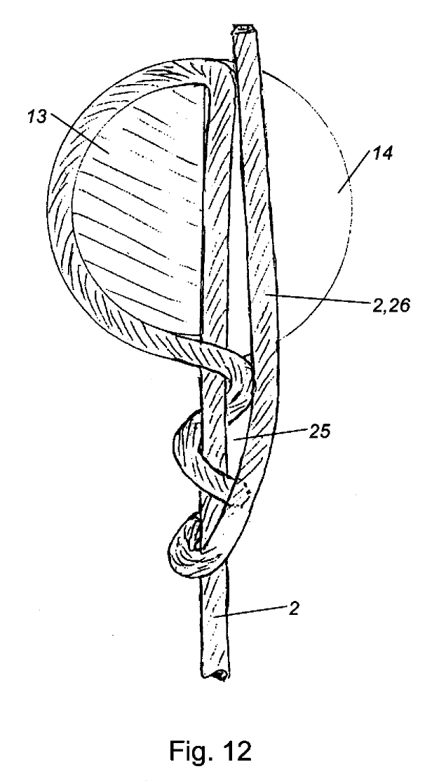

FIG. 12 shows a preferred linkage of a bore of a musical string to a metal button.

FIGS. 3 and 4 show a musical string, especially for stringed and/or plucked instruments, with the musical string 1 having at least one core 2 and with the musical string 1 having at least one first sheathing 3 which is arranged about the first core 2, with the core comprising a predeterminable plurality of metal wires 4 which are stringed together.

A musical string 1 can thus be formed which has a very natural and warm sound. Moreover, such a musical string 1 has a high tuning stability and it is not necessary to re-tune the instrument as frequently as conventional musical strings. Musical strings 1 in accordance with the invention also respond less strongly than known musical strings to a change of location and changes in weather. As a result of a core 2 made of a rope, such a musical string 1 has a low bending stiffness, thus allowing the generation and formation of a large number of upper harmonics. Musical strings 1 in accordance with the invention therefore have a sound rich in timbre.

The various embodiments shown in the drawings are shown in a simplified view. The proportions need not correspond to the intended real proportions. Individual parts can be shown in a highly enlarged view or with so-called auxiliary lines for offering improved understanding. Individual figures can show embodiments of the musical string 1 which do not show all features relevant for the invention if this serves the purpose of better and clearer illustration. Such illustrations or embodiments are not in contravention of the invention.

A preferred field of use for such musical strings 1 is the instruments of the family of violins such as the violin, viola, cello and bass and contrabass. Further preferred instruments for using the musical strings 1 in accordance with the invention are guitars and mandolins. Such musical strings 1 in accordance with the invention can be provided for all stringed and plucked instruments such as cembalos, harps, banjos, sitars, dulcimers, zithers, lutes, oods, p'i-p'as, gekkins, balalaikas, vinas, tampuras, kotos, sohs, etc.

Musical strings 1 in accordance with the invention are provided for generating sound-making oscillations, with a musical string 1 being provided for use in a specific musical instrument and further having a concert pitch and sound post as features, with the concert pitch determining the sound with which a portion of the musical string 1 will oscillate (between its end sections) from the length of the scale of the musical instrument for which it is provided when the musical string 1 is loaded with the sound post and is therefore tensioned.

Musical strings 1 generally have a means for mounting the musical string 1 on a part of the respective musical instrument. This means for mounting can be formed in simple embodiments by a loop or a knot in the musical string 1. It is preferably provided, as shown in FIGS. 3 and 12, that the musical string 1 is delimited at a first end by a sleeve or a ball which especially comprises metal and which is generally also designated as button or metal button 13. The musical string 1 further comprises preferably at least at one end a so-called wrapping 16, 17. It is especially preferably provided as shown in FIG. 3 that the musical string 1 comprises a first wrapping 16 at its first end and a second wrapping 17 at its second end which protects the musical string 1 from excessive edge load during mounting on the pegs of a musical instrument. The wrappings 16, 17 which are often arranged in colors are preferably made of artificial and/or natural fibers, especially artificial or natural silk with a fineness between 50 dtex and 1000 dtex. The end of the fiber is usually tightly glued after forming the wrapping 16, 17 or will adhere as a result of the natural attraction forces on the wrapping. It can further be provided that instead of at least one of the wrappings 16, 17 the musical string 1 is protected in the respective regions by an elastic coating which is applied by immersing the first and/or second end of the musical string 1 into a dipping bath. The coating preferably comprises an elastomer, especially comprising natural caoutchouc or latex. By coating the ends of a musical string 1 in accordance with the invention, the production of such a musical string 1 can be simplified substantially because in this way a complex process with a fast-rotating machine can be replaced by the simple lowering of a musical string into a dipping bath. Production costs and the likelihood of injury during production are lowered. The labeling of the different musical strings 1 is supported by the color arrangement.

Especially preferred embodiments of the musical strings 1 in accordance with the invention have a metal button 13 which is rotationally symmetrical, especially barrel-shaped or partially spherical, for mounting the musical string 1 on a musical instrument. FIG. 12 shows such a preferred provided metal button 13 which is arranged in a substantially barrel-shaped way. The special shape of the metal button 13 ensures that it can be threaded through the openings of a conventional tailpiece. This helps ensure that it is possible to avoid threading musical strings 1 completely through a tailpiece. The process of changing strings is thus considerably simplified. The metal button 13 comprises at least one slit 14. The core 2 of the musical string 1 is guided through said slit 13 and further extends along a groove which the metal button 13 preferably comprises as an extension of slit 14. The end portion 26 of core 2 is then wound or wrapped at least twice around the portion of core 2 facing the playing region of musical string 1, as is shown in FIG. 12, and is then clamped in slit 14, with slit 14 being compressed for this purpose. The end of core 4 protruding beyond the metal button 13 is severed before completing the musical string 1 and is ground off in particular. An opening 25 is provided in the kind of linkage of core 2 to a metal button 13 as described above, which is provided advantageously for fastening the first wrapping 16.

The invention also relates to a method for fastening a musical string 1 to a metal button 13 which comprises a slit 14, with an end portion 26 of a core 4 of the musical string 1 being guided through the slit 14, with subsequently the end portion 26 being wrapped around the metal button 14, with subsequently the end portion 26 being wrapped at least one and half times about the core 2 facing a playing region of the musical string 1, with subsequently the end portion 26 being introduced into the slit 14, and with subsequently the slit 14 being compressed. The linkage in accordance with the invention can ensure a secure connection of the musical string 1 with the metal button 13 which will withstand high tensile forces in the case of bass and cello strings. Moreover, the linkage of the core 2 with the metal button 13 in accordance with the invention further has advantageous acoustic properties. This place of the musical string 1 forms the area where the musical string 1 comes into interaction with the musical instrument at a tailpiece. It has been seen that the manner of linking the core 2 to the metal button 13 as described above leads to an improvement in the response and transient of the musical string 1 on the musical instrument. Stringed instruments equipped with such musical strings 1 respond especially quickly to changing sounds and oscillations excited by the musician and follow remarkably quick to a change of the bow. Musical strings 1 in accordance with the invention comprise a core 2 which is provided and arranged to take up the load and tension to which the musical string 1 in a state when tensioned on a musical instrument. Core 2 of a musical string 1 in accordance with the invention comprises a predeterminable plurality of metal wires 4 which are stranded together with each other. The individual metal wires preferably concern steel wires or copper wires with a diameter of between 0.05 mm and 0.52 mm. Wires of other metal such as titanium can be provided.

The core of musical string 1 preferably comprises an inside core rope 9 and an outside core rope 11 encompassing the inside core rope 9. In a first preferred embodiment, the inside core rope 9 comprises at least one inside core rope wire 10 which is wound in a helical manner about a center of core 2. In a second preferred embodiment, the inside core rope 9 comprises three core inside rope wires 10 which are wound about the center of core 2. The individual inside core rope wires 10 have a predeterminable inside-rope angle of twist α relative to the longitudinal extension of musical string 1 which is between 10° and 60°. The inside core rope wires 10 are wound to rest on each other in such a way that the inside core rope 9 thus formed is capable of high extension under tensile load.

In the case of both preferred embodiments of an inside core rope 9 it can preferably be provided that a core insert 8 which comprises a predeterminable number of polymer threads is arranged substantially in the center of the core 2. It is preferably provided that the polymer threads are arranged to comprise PEK, PEEK, PBT, polyester, nylon, polyethylene, PET, PEET, PES, PE, PP, POM, PTFE, PVDF, PVDC and/or PVC. It is provided in an especially preferred way that the polymer threads are made of polyamide 6.4, 6.6, 6.10 or 6.12 with a fineness of 180 dtex to 250 dtex or of polyester PES with a fineness between 1000 dtex and 1150 dtex. Combinations of different polymer fibers can also be provided.

In the preferred embodiments of a musical string 1, the inside core rope 9 is enclosed by an outside core rope 11. The outside core rope 11 comprises a predeterminable number of outside core rope wires 12 which are wound or stranded in a predeterminable outside-core angle of twist β of between 10° and 60° about the inside core rope 9 relative to the longitudinal extension of the musical string 1. It is preferably provided that the outside core rope 11 comprises six to twelve outside-core rope wires 12. It is provided in especially preferred embodiments of musical strings 1 in accordance with the invention that the diameter of the individual outside-core rope wires 12 is the same and larger than the diameter of the inside-core rope wires 10.

FIGS. 1 and 2 each show a cross section of an especially preferred embodiment of a core 2 of a musical string 1 in accordance with the invention, with the respective three inside-core rope wires 10 and the respective nine outside-core rope wires 12 which enclose the inside core rope 9 are shown in a sectional view. Hatching of the intersecting surfaces was omitted for better clarity of the illustration. The circuit drawn about the inside core rope 9 and the outside core rope 11 is used merely for illustrating the regions of the inside core rope 9 and the outside core rope 11 and need not appear in actually implemented musical strings 1. Such limits of the inside core rope 9 and outside core rope 11 can actually be arranged by bonding agents in a manner at least equivalent to the illustration according to FIGS. 1 and 2. Core 2 according to FIG. 2 differs from a core 2 according to FIG. 1 by the core insert 8 which is arranged in the center of core 2 and comprises a predeterminable number of polymer threads or fibers. It can be provided that the outside-core rope wires 12 are arranged in a crossed way relative to the inside-core rope wires 10. It can also be provided that they are arranged in so-called equal lay. The torsion behavior of the musical string 1 can especially be influenced in this way in a predeterminable manner. The inside-rope angle of twist α and outside-rope angle of twist β of a core 2 preferably have the same size.

Cores 2 for musical strings 1 in accordance with the invention are stranded in such a way that they advantageously offer large extension capabilities and high elasticity, which distinguish them from other conventional steel ropes or wire ropes, as are used for example in technology as transport ropes or Bowden cables. As a result of the high extension capability of the core 2, such a musical string 1 will offer only very little resistance to changes in length occurring during an oscillation on a musical instrument, providing such musical strings 1 with a very good acoustic behavior. As a result of high extensibility which can be up to 30% of the original length and the low bending stiffness, the generation of sound-generating oscillations with a high percentage of harmonics is supported positively. In exciting a musical string 1 by means of a bow, a so-called Helmholtz corner is formed, which is a corner or edge revolving on the musical string 1, with the extent of harmonics that the oscillation of the musical string 1 has being proportional to the “sharpness” of the Helmholtz corner, which means that the more distinct this corner is, the more harmonics or timbre are produced.

Musical strings 1 in accordance with the invention comprise at least a first sheathing 3. It can be provided that the first sheathing 3 is arranged substantially directly on the core 2. It can also be provided, as in the musical string according to FIG. 4, that a first intermediate layer 18 is arranged on the core 2 and that the first intermediate layer 18 comprises a predeterminable number of polymer fibers, with the polymer fibers of the first intermediate layer 18 being preferably arranged in an equivalent manner to the polymer threads of the core insert 8. As is shown in FIG. 4, it is preferably provided that the first intermediate layer 18 is formed by a bundle which has a predeterminable number of polyamide fibers which are arranged substantially parallel to the longitudinal extension of the musical string 1. It can also be provided however that the first intermediate layer 18 is formed by a bundle that has a predeterminable number of polyamide fibers and that the bundle is wound in a helical way about the core 2. The first intermediate layer 18 ensures that the damping of the musical string 1 can be influenced in a predeterminable way. By aligning the first intermediate layer 18 parallel to the longitudinal extension of the musical string 1 or winding the same in a helical manner about core 2, the torsional oscillation behavior of the musical string 1 can be influenced in a predeterminable way.

Musical strings 1 in accordance with the invention comprise at least a first sheathing 3. Said first sheathing 3 can be arranged as any kind of sheathing, winding or covering of the musical string 1. It is provided in an especially preferable way that the first sheathing 3 is wound in a helical way about the core 2. This leads to an especially advantageous way of increasing the mass cover of musical string 1. The bending stiffness of the musical string 1 can be kept at an advantageously low level as a result of the helical arrangement of sheathing 3. In this way, the formation of a large number of high partial tones is enabled during the excitation of the musical string 1, thus enabling a play rich in tone colors with such a musical string 1.

It is provided in a helical arrangement of the first sheathing 3 that the first sheathing 3 consists of at least a first round wire or at least a first strip of a substantially rectangular cross section with predeterminable edge arrangement. The first round wire 5 or the first strip are wound during production of the musical string 1 on the core 2. It can be provided that the first round wire 5 or the first strip are wound so as to lie close to one another, with no cavities occurring substantially between the individual adjacent windings. It can also be provided that a predeterminable cavity is provided between the individual adjacent windings. By arranging the first sheathing 3 as a round wire 5 or as a first strip, an especially simple production of the musical string 1 can be achieved.

It can be provided in a further development of the invention that the first sheathing 3 further comprises a second round wire and that the first round wire 5 and the second round wire are wound lying adjacent to one another in a helical way about the core 2, or that the first sheathing 3 further comprises a second strip with a substantially rectangular cross section with a predeterminable edge formation, and that the first strip and the second strip are wound lying adjacent to one another in a helical manner about the core 2. The bending stiffness of the musical string 1 can be lowered at a substantially unchanged mass coating, as a result of which the richness of tone colors that can be achieved with such a musical string 1 can be increased.

The round wire 5, 7 can concern any kind of round wire 5, 7. It is provided especially that the at least one round wire 5, 7 has a diameter of between 0.05 mm and 0.4 mm. It can further be provided that the at least one round wire has a substantially straight circumferential line at least in sections. Such a substantially straight circumferential line can be formed by grinding off a sheathing formed from round wires. The special properties of round wires can thus be combined with those of a strip.

Furthermore, each strip 20 can be provided for forming the sheath. It is preferably provided that the at least one strip 20 is between 1.25 and 30 times as thick as it is wide.

The strip 20 with a substantially rectangular cross section with predeterminable edge formation preferably concerns a strip 20 with a cross section which essentially has the dimensions of a rectangle, with the formation of the edges of the strip 20 being predeterminable. FIGS. 5 to 11 show seven especially preferred embodiments of a strip 20 in a cross-sectional view. The first preferred embodiment of a strip 20 according to FIG. 5 has a substantially rectangular cross section in the mathematical sense, with the tolerances of parallelism of the individual surfaces and deviations of the angles between the mutually adjacent surfaces 21, 22, 23, 24 being provided within the range of the usual production tolerances.

The second and third preferred embodiments of a strip 20 according to FIGS. 6 and 7 have a cross section which has two parallel surfaces which are substantially in the range of production tolerances and which have the shape of a cover surface 21 and a bottom surface 22, with the lateral surfaces 23, 24 being arranged as a so-called natural edge. Such a strip 20 is formed for example by rolling a wire without aftertreatment of the lateral surfaces 23, 24. The lateral surfaces 23, 24 preferably have a shape which is formed from a predeterminable sequence of predeterminable conic section lines. The third preferred embodiment of a strip 20 in accordance with FIG. 8 has lateral surfaces which are substantially arranged in a planar way in sections.

The fourth, fifth and sixth preferred embodiments of a strip 20 according to FIGS. 8, 9 and 10 each have a cross section which is formed by special rolling processes. As a result of different shapes, formerly unattainable acoustic and playing properties in musical strings 1 can be achieved. A strip 20 according to the fourth preferred embodiment comprises a first lateral surface 23 and a second lateral surface 24 which are shaped in such a way that in the case of a helical winding of the strip 20 onto a core 2 of a musical string 1, with the first lateral surface 23 being arranged substantially directly adjacent to the second lateral surface 24, the first lateral surface 23 grasps behind the adjacent second lateral surface 24 at least in sections, so that an assembly is formed. The lift-off of individual windings from the strip 20 can thus be prevented. Furthermore, the penetration of dirt beneath a sheathing can be prevented, which sheathing is formed by a strip 20 according to the fourth preferred embodiment.

The fifth and sixth preferred embodiment of a strip 20 according to FIGS. 9 and 10 each have a first and second lateral surface 23, 24 which faces towards the inside of the cross section or is arranged in a concave manner. Regions can thus be created in which additional damping or bonding agents 15 can be arranged. Damping agents are preferably viscopolymer liquids. The preferred bonding agents 15 mentioned at another place can be provided as bonding agents 15. The inner damping of the musical string 1 can thus be increased in a predeterminable manner, as a result of which such a musical string 1 can be controlled better when excited by playing.

The seventh preferred embodiment of a strip 20 according to FIG. 11 has a cross section in which the first lateral surface 23 and the second lateral surface 24 are arranged substantially parallel with respect to one another relative to the cover surface 21 or bottom surface 23, thus enabling a shingle-like arrangement of the windings of a sheathing 3, 6, 19 which are arranged next to one another. The penetration of dirt can thus be effectively prevented, which thus further increases the service life of the musical strings 1.

Each of the strips 20 described in the present descriptions preferably has a cross section according to one of the previously described seven preferred embodiments.

In respect of the further described especially preferred embodiments, detailed examples for especially advantageous dimensioning of round wires 5, 7 and strips 20 for the musical strings 1 in accordance with the invention are mentioned, so that a further listing of preferred embodiments can be omitted here.

It is preferably provided that the at least one round wire 5, 7 or the at least one strip 20 is arranged to comprise a metallic material. This combines the advantages of a high density and rough surface which is advantageous for excitation by a bow because colophony adheres especially well on such a rough surface. It is provided in an especially preferred way that the at least one round wire 5, 7 or the at least one strip 20 is formed to comprise at least one material from the group of aluminum, magnesium, iron, chromium, nickel, silicon, silver, gold, platinum, rhodium, copper, tungsten, with each of the mentioned materials being provided as a pure material in the technical sense, but also as a component of an alloy. Musical strings 1 have proven to be especially advantageous in which the at least one round wire 5, 7 or the at least one strip 20 is formed to comprise at least one alloy chosen from the group of steel, aluminum/magnesium alloys, aluminum/magnesium/manganese alloys, silver/copper alloys, silver/platinum alloys, silver/rhodium alloys, silver/palladium alloys, iron/chromium/nickel/silicon/aluminum alloys. Steel preferably concerns steel comprising alloy components chosen from the group of carbon, chromium, nickel, molybdenum, vanadium, manganese, tungsten, with carbon steels (carbon content of 0.01% to 0.03%) and chromium/nickel steels (chromium content of 17% to 20%, nickel content of 8% to 10%) being especially preferable. It can further be provided that the at least one round wire 5, 7 or the at least one strip 20 has a surface coating, with a coating being provided with at least one metal, especially brass, tin, nickel, and/or a plastic, especially a polymer. It can preferably be provided that a predeterminable number of coatings can be arranged above one another.

In a further development of the invention it is provided especially preferably that a musical string 1 in accordance with the invention has a second sheathing 6 which is wound in a helical manner about the first sheathing 3, through which advantageously a further mass coating can be applied to the same without excessively increasing the bending stiffness of the musical string 1. The second sheathing 6 which is preferably formed from a third round wire 7 or a third strip with a substantially rectangular cross section can be applied in the same winding sense as the preceding first sheathing 3 or in a winding sense which is contrary to or crosses the winding sense of the first sheathing 3. This shall be referred to below as “crossed”. As a result of the crossed arrangement of the second sheathing 6 relative to the first sheathing 3, an especially homogeneous musical string 1 can be formed.

It can be provided in an equivalent manner to the arrangement of the first sheathing 3 that the second sheathing 6 further comprises a fourth round wire and that the third round wire 7 and the fourth round wire are wound lying next to one another in a helical manner about the core 2, or that the second sheathing 6 further comprises a fourth strip with a substantially rectangular cross section and that the third strip 7 and the fourth strip are wound lying next to one another in a helical manner about the core 2. The arrangement of the round wires 7 or strips is preferably arranged in an equivalent manner to the embodiments described in the description of the first sheathing 3.

It is preferably further provided that the musical strings 1 in accordance with the invention comprise at least a third sheathing 19 which is wound in a helical manner about the second sheathing 6. It can also be provided in this case that the third sheathing 19 is arranged in a crossed manner relative to the second sheathing 6. The arrangement of the round wires or strips 20 is preferably arranged in an equivalent manner to the embodiments described in the description of the first sheathing 3. FIG. 4 shows an embodiment of a musical string in accordance with the invention with a first, second and third sheathing 3, 6, 19.

Furthermore, a predeterminable number of further sheaths can be provided, with especially a fourth, fifth and sixth sheathing being provided which are all preferably arranged in an equivalent manner to the embodiments described in the description of the first sheathing 3 as regards arrangement, dimensioning and materials.

It can further be provided that a polymer coating is provided as the outermost layer of musical string 1, e.g. in the form of a plastic tube or a so-called bi-stage lacquer. It is preferably provided in this case that a polymer cover tape is wound up onto the musical string 1 in a helical manner. In this context it is provided preferably that the edges of the polymer cover tape arranged helically on the musical string are molten together. It is provided for this purpose to subject the musical string 1 to a predeterminable heating. A jacket about the musical string 1 is closed which is impenetrable for dirt and humidity, thus further increasing the service life of the musical string 1.

It can be provided that the first sheathing 3 is arranged directly on the core 2 and that the further provided sheathings are arranged to follow directly one after the other. It can also be provided that a bonding agent 15 is arranged at least between the first sheathing 3 and the second sheathing 6, preferably comprising wax, especially natural waxes such as bees wax or carnauba wax, and/or artificial waxes such polyolefin waxes, paraffin, oil, such as greasy oils, mineral oil, and/or synthetic oils such as resin, especially natural resins such as larch resin and/or spruce resin, and/or synthetic resins such as polyester resin, phenol resin and/or epoxy resin. Such a bonding agent 15 can also be arranged between core 2 and the first sheathing 3. It is further preferably provided to arrange a bonding agent 15 as described above between the inside core rope 9 and the outside core rope 11. The bonding agent 15 can be used to change the inner damping of the musical string 1 in a predeterminable way, especially to increase the same, which is especially advantageous for musical strings 1 for stringed instruments.

A number of especially preferred embodiments of a musical string 1 in accordance with the invention will be described below:

FIG. 4 shows constructional details of musical strings 1 in accordance with the invention by way of example. The illustrated musical string 1 comprises a core 2 which is made up of three stranded inside-core rope wires 10 and six outside-core rope wires 12 which are stranded to the same in a crossed manner. A core insert 8 is arranged in the center of the core 2. The illustration also shows the inside-rope angle of twist α and the outside-rope angle of twist β and the so-called length of lay S as a further characteristic of a rope. The length of lay S corresponds substantially to the pitch or inclination with which a wire of the inside core rope 9 or the outside core rope 11 is wound. As is shown in FIG. 4, the length of lay S is therefore the path by which a wire has moved forward during a complete rotation or winding of the center. It can be provided in especially preferred musical strings 1 that the length of lay S of the outside-core rope wires 12 is 1.1 to 3 times, especially 1.5 to 2.5 times, preferably 1.8 to 2.2 times, as large as the length of lay S of the inside-core rope wires 10, thus achieving an especially warm and dark sound of the musical string 1.

The exemplary musical string 1 according to FIG. 4 further comprises a first sheathing 3 which is formed by a first round wire 5 and a second sheathing 6 which is formed by a third round wire 7, with the diameter of the first round wire 5 being larger than the diameter of the second round wire 7, the second round wire 7 being wound in the same direction of winding as the first round wire 5, and the second round wire 7 being arranged in the abutting points of the first round wire 5 which is wound so as to sit tightly close to one another. This leads to intermediate spaces between the individual windings of the second round wire 7. A third sheathing 19 in the form of a fifth strip 20 is arranged on the second sheathing 6. A bonding agent 15 which is not specifically shown is arranged in the intermediate spaces or cavities between the individual windings, which bonding agent is merely illustrated in FIG. 4 by reference numerals.

Core 2 of the especially preferred first and second embodiments of musical strings 1 in accordance with the invention as described below is made of steel wires, and comprises three inside-core rope wires 10 and six outside-core rope wires 12, with the outside-core rope wires 12 being arranged in a crossed manner relative to the inside-core rope wires 10. A core insert 8 is provided in the center of the inside core rope 9. A bonding agent 15 is arranged between the individual inside-core rope wires 10 and the outside-core rope wires 12. The inside-core rope wires 10 and the outside-core rope wires 12 have the inside-rope angle of twist α and an outside-rope angle of twist β of between 40° and 50°. As a result of the high inside-rope angle of twist α and outside-rope angle of twist β, an especially high extensibility of the core 2 is achieved because the same can be pulled apart similar to the effect of a coil spring and will move back to an idle position again. The inside-core rope wires 10 preferably have a diameter of between 0.05 mm and 0.27 mm and the outside-core rope wires 12 have a diameter of between 0.06 mm and 0.34 mm. It is preferably provided that the inside-core rope wires 10 have a smaller diameter than the outside-core rope wires 12.

In a first preferred embodiment of a musical string 1 in accordance with the invention, an intermediate layer 18 made of polymer fibers with approx. 95 to 115 dtex is arranged on said core 2 as described above, which fibers are arranged substantially parallel to the longitudinal extension of the musical string 1. The polyamide fibers are preferably connected by means of the bonding agent 15 with the core 2. The first sheathing 3 is formed by a round copper wire which is wound in a helical manner about the intermediate layer 18. It can be provided in a further arrangement of this embodiment that the first sheathing 3 is formed by three round copper wires which are each wound in a helical manner about the intermediate layer 18 situated adjacent to one another. The round copper wires each have a diameter in the range of between 0.22 mm and 0.25 mm and are arranged in a crossed manner relative to the outside-core rope wires 12. The round copper wires are ground before applying the second sheathing 6 and therefore have flat areas in certain sections. The second sheathing 6 is formed by a single round copper wire which has a diameter of between 0.24 mm and 0.27 min and is arranged in a crossed manner relative to the round copper wires of the first sheathing 3. It is preferably provided that the round copper wire of the second sheathing 6 has a polymer surface coating. A third sheathing 19 in the form of a single round copper wire is arranged on the second sheathing 6, which third sheathing is arranged in the same direction relative to the round copper wire of the second sheathing 6. The round copper wire of the third sheathing 19 has a preferably slightly lower diameter than the round copper wire of the second sheathing 6 and is arranged in the abutment points which are formed between the mutually adjacent parts of the round copper wire of the second sheathing 6. An arrangement is thus formed in which a helical gap is formed which extends over the entire length of the musical string 1 between the mutually closest winding parts of the round copper wire forming the third sheathing 19. The bending stiffness of the musical string can thus advantageously be kept low. FIG. 4 shows a musical string 1 which is similar to the present first preferred embodiment, in which the gap as described above can easily be recognized. A fourth sheathing is arranged on the third sheathing 19 which is formed by a strip made of chromium steel which is arranged in a crossed manner relative to the third sheathing 19 and which has a length of between 0.51 mm and 0.57 mm and a thickness of between 0.15 mm and 0.18 mm. A bonding agent is preferably arranged between all layers and sheathings 3, 6, 19 of the musical string 1 as described above. Such a first preferred embodiment of a musical string 1 in accordance with the invention is preferably provided for low-frequency oscillations such as double bass string E₁.

The second preferred embodiment of a musical string 1 in accordance with the invention has a first preferred embodiment of a musical string 1 in accordance with the invention with a substantially equivalent arrangement, with merely the first sheathing 3 being arranged differently. In the second embodiment, the first sheathing 3 is formed by a first strip comprising aluminum which has a width of between 0.53 mm and 0.58 mm and a thickness of between 0.09 mm and 0.12 mm. A bonding agent 15 is each arranged between the individual layers of the musical string 1 as described above. The second preferred embodiment of a musical string 1 in accordance with the invention has a mass covering which is smaller than that of the first preferred embodiment and is therefore preferably provided for slightly higher-frequency oscillations such as the double bass string A₁.

The further described third preferred embodiment of a musical string 1 in accordance with the invention has a core 2, comprising three inside-core rope wires 10 and seven outside-core rope wires 12 which are each stranded together in a crossed manner with respect to each other at an the inside-rope angle of twist α and an outside-rope angle of twist β of between 40° and 50°. The inside-core rope wires 10 have a diameter of between 0.1 mm and 0.14 mm and the outside-core rope wires 12 have a diameter of between 0.13 mm and 0.17 mm. The third preferred embodiment comprises an intermediate layer 18 in the manner of the first preferred embodiment of a musical string 1. The further provided first and second sheathings 3, 6 are arranged in the manner of the second and third sheathing 3, 6 of the first preferred embodiment, which in this case is each arranged as a single round wire, with the third round wire 7 of the second sheathing 6 being arranged in the abutting points of the first round wire 5 of the first sheathing 3. The first round wire 5 has a diameter of between 0.15 mm and 0.18 mm and the third round wire 7 a diameter of between 0.12 mm and 0.145 mm. The first and third round wire 5, 7 are arranged to comprise tungsten. It is especially provided that the first and third round wire 5, 7 are substantially completely made of tungsten. A bonding agent 15 is each arranged between the individual layers of the musical string 1 as described above. Such a musical string 1 is preferably used as a cello C-string.

The fourth preferred embodiment of a musical string 1 in accordance with the invention comprises a core 2 which is formed by three inside-core rope wires 10 and six outside-core rope wires 12 which are arranged in a crossed manner relative to each other. This core 2 does not comprise any core insert 8. The inside-core rope wires 10 have a diameter of between 0.12 mm and 0.15 mm, the outside-core rope wires 12 have a diameter of between 0.24 mm and 0.28 mm. The inside-rope angle of twist α is approximately 40° and the length of lay S of the outside-core rope wires 12 is substantially twice as large as the length of lay S of the inside-core rope wires 10. The first sheathing 3 is formed by a first round wire 5 which is arranged as a polymer-coated round copper wire and has a diameter, without the polymer coating, of approximately 0.27 mm to 0.3 mm. The second sheathing 6 which is formed from a blank round copper wire with a diameter of between 0.27 mm to 0.3 mm is wound in the same direction of rotation as the first round wire 5 and is arranged, as described, in the abutting points of the first round wire 5. A third sheathing 19 is provided substantially in the same manner, which sheathing is formed by a fifth round wire. The fifth round wire is arranged as a polymer-coated round copper wire with a diameter of between 0.24 mm and 0.27 mm and is arranged in the abutting points of the third round wire 7. The diameters of the first, third and fifth round wire 5, 7 are chosen in such a way that the actual outside diameter of the round wire 5, which is the diameter of the respective round wire 5, 7 together with a coating optionally arranged thereon, is larger than the outside diameter of the third round wire 7, and the outside diameter of the third round wire 7 is larger than the outside diameter of the fifth round wire. A fourth sheathing which comprises a strip is arranged on the fifth round wire, with the width of the strip preferably being substantially larger than twice the outside diameter of the fifth round wire. It can also be provided that the width of the strip is smaller than the sum total of the widths of the round wires arranged in the third sheathing. Such a musical string 1 has a very warm, dark sound.

Further embodiments merely have a part of the described features, with any combination of features being provided, especially also of different described embodiments.

1. A musical string (1), especially for stringed and/or plucked instruments, with the musical string (1) having at least one core (2) and with the musical string (1) having at least a first sheathing (3) which is arranged about the first core (2), characterized in that the core has a predeterminable plurality of metal wires (4).

2. A musical string (1) according to claim 1, characterized in that a core insert (8) comprising a predeterminable number of polymer threads is arranged substantially in the center of the core (2).

3. A musical string (1) according to claim 1 or 2, characterized in that the core (2) comprises an inside core rope (9) which comprises at least one inside-core rope wire (10), especially three inside-core rope wires (10), which is wound about the center of the core (2).

4. A musical string (1) according to claim 3, characterized in that the at least one inside-core rope wire (10) has a predeterminable inside-rope angle of twist (α) of between 10° and 60° against the longitudinal extension of the musical string (1).

5. A musical string (1) according to claim 3 or 4, characterized in that the core (2) comprises an outside core rope (11) which is arranged about the inside core rope (9).

6. A musical string (1) according to claim 5, characterized in that outside core rope (11) comprises a predeterminable number of outside-core rope wires 12, preferably six to twelve thereof, which are wound about the inside core rope (9) at a predeterminable outside-rope angle of twist (β) of between 10° and 60° against the longitudinal extension of the musical string (1).

7. A musical string (1) according to claim 6, characterized in that the outside-core rope wires (12) are arranged in a crossed manner relative to the inside-core rope wires (10).

8. A musical string (1) according to one of the claims 10, characterized in that a length of lay (S) of the outside-core rope wires (12) is 1.1 to 3 times, especially 1.5 to 2.5 times, preferably 1.8 to 2.2 times as large as a length of lay (S) of the inside-core rope wires (10).

9. A musical string (1) according to one of the claims 1 to 8, characterized in that a first intermediate layer (18) is arranged on the core (2) and that the first intermediate layer (18) comprises a predeterminable number of polymer fibers.

10. A musical string (1) according to one of the claims 1 to 9, characterized in that said musical string (1) comprises a first sheathing (3) which is wound in a helical manner about the core (4) and is formed by at least a first round wire (5) and/or a first strip.

11. A musical string (1) according to one of the claims 1 to 10, characterized in that said musical string (1) comprises a second sheathing (6) which is wound in a helical manner about the first sheathing (3), and that the second sheathing (6) comprises at least one third round wire (7) and/or a third strip.

12. A musical string (1) according to claim 11, characterized in that said musical string (1) comprises at least a third sheathing (19) which is wound in a helical manner about the second sheathing (6), and that preferably the third sheathing is arranged in a crossed manner relative to the second sheathing (6).

13. A musical string (1) according to one of the claims 1 to 12, with a substantially rotationally symmetrical metal button (13) for mounting the musical string (1) on a musical instrument being arranged at a first end of the musical string (1), characterized in that the metal button (13) comprises at least a first slit (14) through which the core (2) is guided and in which the core (2) is clamped.

14. A musical string (1) according to claim 13, characterized in that the core (2) is guided at least about half the metal button (13) and is wrapped around the core (2) facing a playing area of the musical string (1).

15. A method for fastening a musical string (1) to a metal button (13) which comprises a slit (14), characterized in that an end portion (26) of a core (4) of the musical string (1) is guided through the slit (14), that thereafter the end portion (26) is wrapped around the metal button (14), that thereafter the end portion (26) is wrapped at least one and a half times around the core (2) facing a playing area of the musical string (1), that thereafter the end portion (26) is inserted into the slit (14), and that thereafter the slit (14) is compressed.
